(19) United States
(12) Patent Application Publication
(10) Pub. No.: US 2024/0238793 A1
(43) Pub. Date: Jul. 18, 2024

(54) Disk Type Pulverizer And Pulverizing Method

(71) Applicant: Nara Machinery Co., Ltd., Tokyo (JP)

(72) Inventors: Yorioki Nara, Tokyo (JP); Takeaki Tamiya, Tokyo (JP); Masaya Kudo, Tokyo (JP)

(73) Assignee: Nara Machinery Co., Ltd., Tokyo (JP)

(21) Appl. No.: 18/562,102

(22) PCT Filed: May 20, 2022
(86) PCT No.: PCT/JP2022/020910

§ 371 Date: Nov. 17, 2023

(30) Foreign Application Priority Data
May 24, 2021 (JP) 2021-087253

(51) Int. Cl. B02C 7/14; B02C 7/06; B02C 7/12

(52) U.S. Cl. CPC B02C 7/14; B02C 7/06; B02C 7/12

(57) ABSTRACT

A disk type pulverizer including a pair of disks capable of high-speed rotation is provided. In the disk type pulverizer, a pulverizing object is supplied to a first region on a disk rotation shaft side in a space region between the pair of disks 2 and 3, a minimum space G1min in the first region of the space region is set to be wider than a minimum space G2min in a second region outside the first region of the space region, and a pulverizing part is formed in a part of a counter surface that corresponds to the second region. Each of the pair of disks 2 and 3 includes a central disk part on the first region side and a pulverizing disk part on the second region side, and the pulverizing disk part includes a balance weight part on a part on a side opposite to the counter surface.

### TECHNICAL FIELD

The present invention relates to a disk type pulverizer and a pulverizing method using the same.

### BACKGROUND ART

Pulverizing is a mechanical operation of destroying a solid pulverizing object by applying an external force on the pulverizing object so as to reduce the particle diameter thereof or increase the surface area thereof. Examples of the action of the external force on the pulverizing object in pulverizing include compression, impact, shearing, and friction. Pulverizing is classified roughly into cracking, coarse pulverizing, fine pulverizing, and the like depending on the target particle diameter after the pulverizing. The fine pulverizing is an operation of pulverizing a raw material particle, which correspond to a pulverizing object on the order of millimeter into the size of about 10 μm or less.

The fine pulverizing includes wet pulverizing and dry pulverizing. The wet pulverizing is an operation of pulverizing the raw material particles in a state of being diffused in liquid such as water. The dry pulverizing is a pulverizing operation performed in the atmosphere.

Main pulverizers capable of dry fine pulverizing include a high-speed rotation type impact pulverizer, a jet mill, and a disk type pulverizer.

Examples of the high-speed rotation type impact pulverizer include a hammer mill and a pin mill. The hammer mill pulverizes the raw material particles by causing a rotor with an impact member to rotate at high speed and apply an impact on the raw material particles, thereby pulverizing the raw material particles. The pin mill pulverizes the raw material particles by causing a rotor with a pin, a blade, or the like fixed to rotate at high speed and apply an impact on the raw material particles, thereby pulverizing the raw material particles. In any of the hammer mill and the pin mill, the pulverized particles pass a screen provided on an outer peripheral side and the particle size of the particle after the pulverizing is adjusted by the size of the opening of the screen.

The jet mill accelerates the raw material particles by a jet airflow obtained by jetting compressed air or high-pressure gas, and by the collision or impact action, pulverizes the raw material particles. As the jet mill, there are an impact plate type using an impact member such as an impact plate, and a counter airflow type and a fluidized layer type that pulverizes the raw material particles by the collision between the raw material particles or between the raw material particle and a flow channel wall surface. In the jet mill of the impact plate type, as the adhesion or fixture to the impact member progresses, the pulverizing performance decreases. Therefore, for the raw material particles with high adhesion, the counter airflow type or the fluidized layer type is used.

In the counter airflow type or fluidized layer type jet mill, the particles are pulverized so that the surface of the particle is cut back and the surface pulverizing easily occurs; accordingly, the particles with the corners rounded and the smooth surface are obtained. Therefore, in the counter airflow type or fluidized layer type jet mill, a large quantity of fine powder with smaller diameter than the target particle diameter is generated.

A device main body of the jet mill does not have a mechanically movable part and does not have a power source such as motor attached thereto. Therefore, the jet mill seems a small device at a glance. The jet mill, however, receives the supply of compressed air and is configured by a huge system including a large compressor. As a result, the operation of the jet mill requires a large consumption power. In the jet mill, a large amount of energy to be consumed by the compressor is used for other than the pulverizing and the loss of energy is extremely large.

The disk type pulverizer, unlike the jet mill, is a pulverizer that does not require compressed air for fine pulverizing. The disk type pulverizer includes a pair of disks that face each other with a space therebetween and are rotated and driven in directions opposite to each other. The raw material particles are supplied into the space between the pair of disks (also called narrow gap). In the disk type pulverizer, the raw material particles are pulverized by pulverizing means (pulverizing part) such as a groove or a blade provided to counter surfaces of the disks when the raw material particles pass the narrow gap. As the pair of disks are rotated and driven in the directions opposite to each other, the disk type pulverizer can drastically increase the relative speed between one disk and the other disk compared to when one disk is fixed. In the disk type pulverizer, in the process for the raw material particles to pass through the narrow gap, the raw material particles are pulverized by the complicated actions including the collision between the particles and the groove or the like, the collision between the particles, and the re-collision thereof. The re-collision occurs due to, for example, turbulence generated in the narrow gap.

One example of the disk type pulverizer is a disk type fine pulverizer for synthetic resin pulverizing according to Patent Document 1. In this disk type fine pulverizer, a number of blades are arranged extending in a radial direction in an annular part near the outer periphery of a counter surface (circular surface) of each disk and the distance between the tip of the blade of one disk and the tip of the blade of the other disk becomes narrower toward the outer periphery of the disk. In the disk type fine pulverizer, the distance between the outer peripheries of the pair of disks that face each other is 0.05 to 0.25 mm and the relative speed between the pair of disks is 150 to 250 m/s at the outer periphery.

### CITATION LIST

### Patent Document

[Patent Document 1] Japanese Patent Laid-Open No. 59-32956

### SUMMARY OF INVENTION

### Technical Problem

In the disk type fine pulverizer described in Patent Document 1, however, merely about 150 to 250 m/s is assumed as the relative speed of the pair of disks. In the disk type pulverizer, further higher-speed rotation of the disks may be demanded.

The present invention has been made in view of the above circumstances, and an object is to provide a disk type pulverizer including a pair of disks facing each other closely and capable of rotating at higher speed than before, and a pulverizing method using the same.

### Solution to Problem

According to one aspect of the present invention, a disk type pulverizer is provided. This disk type pulverizer includes a pair of disks that face each other with a space therebetween and are rotated and driven in directions opposite to each other, and a supply part that supplies a pulverizing object to a first region on a disk rotation shaft side in a space region between a counter surface of one disk of the pair of disks with respect to the other disk and a counter surface of the other disk with respect to the one disk. In the disk type pulverizer, a minimum space in the first region of the space region is set to be wider than a minimum space in a second region outside the first region of the space region, and a pulverizing part for pulverizing the pulverizing object is formed in a part of the counter surface that corresponds to the second region. Each of the pair of disks includes a central disk part on a side of the first region and a pulverizing disk part on a side of the second region, and the pulverizing disk part includes a balance weight part in a part on a side opposite to the counter surface.

According to another aspect of the present invention, a pulverizing method is provided. This pulverizing method is a method of pulverizing the pulverizing object using the disk type pulverizer according the one aspect. The pulverizing method includes sectioning each of the pair of disks into a central disk part on the side of the first region and a pulverizing disk part on the side of the second region, and providing a balance weight part in a part of the pulverizing disk part on a side opposite to the counter surface.

### Advantageous Effects of Invention

In the disk type pulverizer according the one aspect and the disk type pulverizer used in the pulverizing method according to the other aspect, the minimum space in the first region of the space region is set to be wider than the minimum space in the second region outside the first region of the space region, and the pulverizing part for pulverizing the pulverizing object is formed in a part of the counter surface that corresponds to the second region. Therefore, the minimum space in the second region of the space region is set to be narrower than the minimum space in the first region. That is to say, each of the disks of the disk type pulverizer has the fundamental structure in which the pulverizing disk part protrudes in the disk thickness direction relative to the central disk part in the counter surface. In other words, each of the disks of the disk type pulverizer has the fundamental structure in which the central disk part is depressed in the disk thickness direction relative to the pulverizing disk part in the counter surface.

Here, as a result of earnest examinations by the inventor of this application, the following are discovered: (1) according to the aforementioned fundamental structure, a bending moment that warps the pulverizing disk part in a direction away from the counterpart disk (that is, warping toward the disk rear surface) due to the centrifugal force acting on the pulverizing part at the rotation and driving of the disks acts on the pulverizing disk part of each disk, specifically, due to the centrifugal force, a rotation moment occurs in the pulverizing disk part and this rotation moment acts as the bending moment in the root of the pulverizing disk part; (2) in particular, at the rotation and driving at higher speed than before, the disks may be deformed at the border part between the central disk part and the pulverizing disk part by the bending moment and the narrow gap between the pair of disks may not be kept; and (3) in this case, the pulverizing disk part can be deformed to be warped toward the disk rear surface; thus, the stable rotation becomes difficult and vibration and the like occur, and accordingly, which would make it difficult to rotate and drive the pair of disks at the higher speed than before with the pair of disks kept close to each other.

In this regard, in the disk type pulverizer according to the one aspect, in the structure based on the fundamental structure, each of the pair of disks includes the central disk part on the side of the first region and the pulverizing disk part on the side of the second region, and the pulverizing disk part includes the balance weight part in the part on the side opposite to the counter surface. That is to say, the balance weight part is provided to the part of the pulverizing disk part on the opposite side of the pulverizing part that causes the bending moment (rotation moment) to warp the pulverizing disk part toward the disk rear surface. Therefore, the balance weight part can cause the bending moment (rotation moment) in the direction of canceling the bending moment in each of the disks to act on the pulverizing disk part. As a result, by providing the balance weight part as appropriate in accordance with the pulverizing part, the narrow gap between the pair of disks can be kept and the pair of disks can be rotated and driven at the higher speed than before with the pair of disks kept close to each other.

In this manner, the disk type pulverizer including the pair of disks facing each other closely and capable of rotating at higher speed than before, and the pulverizing method using the same can be provided.

### BRIEF DESCRIPTION OF DRAWINGS

FIG. 1 is an overall view for describing an internal structure and an entire structure of a main part of a disk type pulverizer according to one embodiment of the present invention.

FIG. 2 is a right side view of the disk type pulverizer.

FIG. 3 is an enlarged cross-sectional view of a main part of the disk type pulverizer.

FIG. 4 is a conceptual view for describing the space between a pair of disks in the disk type pulverizer.

FIG. 5 is a front view of the disk in the disk type pulverizer.

FIG. 6 is a cross-sectional view of the disk.

FIG. 7 is a conceptual view for describing the warpage of a pair of comparative disks according to a comparative example to be compared with the pair of disks.

FIG. 8 is a conceptual view for describing the rotation moment of each of the comparative disks.

FIG. 9 is a conceptual view for describing the rotation moment of each of the disks.

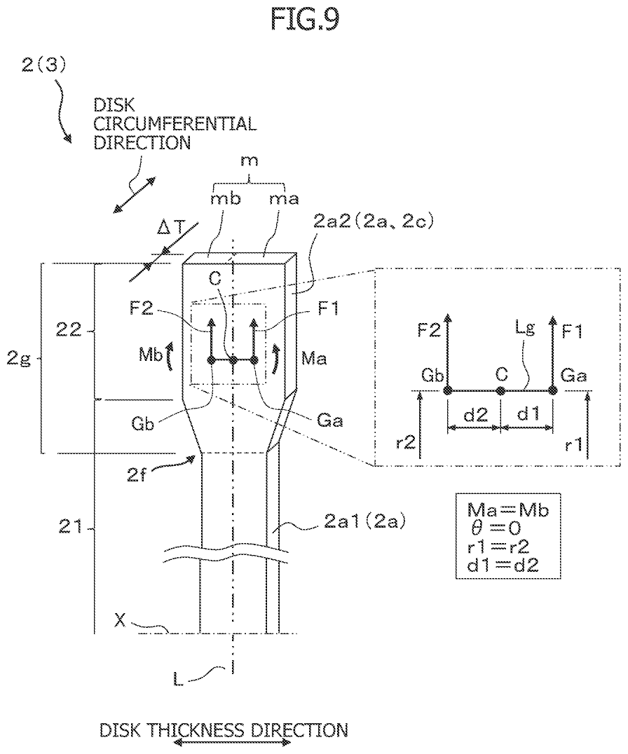

FIG. 10 is a main part enlarged cross-sectional view for describing a modification (Modification 1) of the pair of disks in the disk type pulverizer.

### DESCRIPTION OF EMBODIMENTS

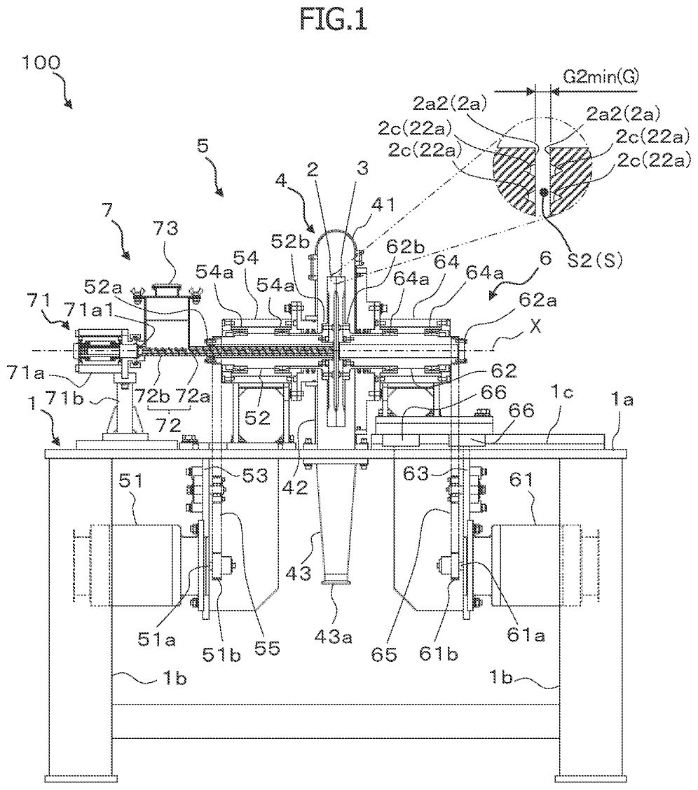

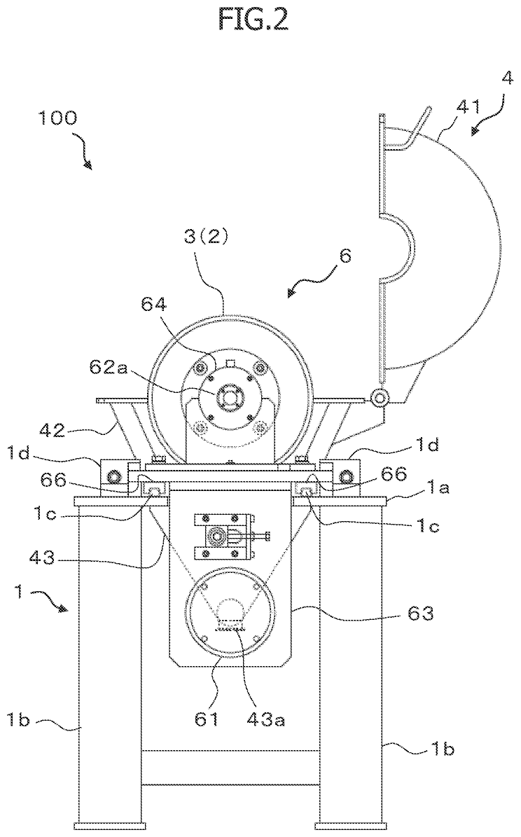

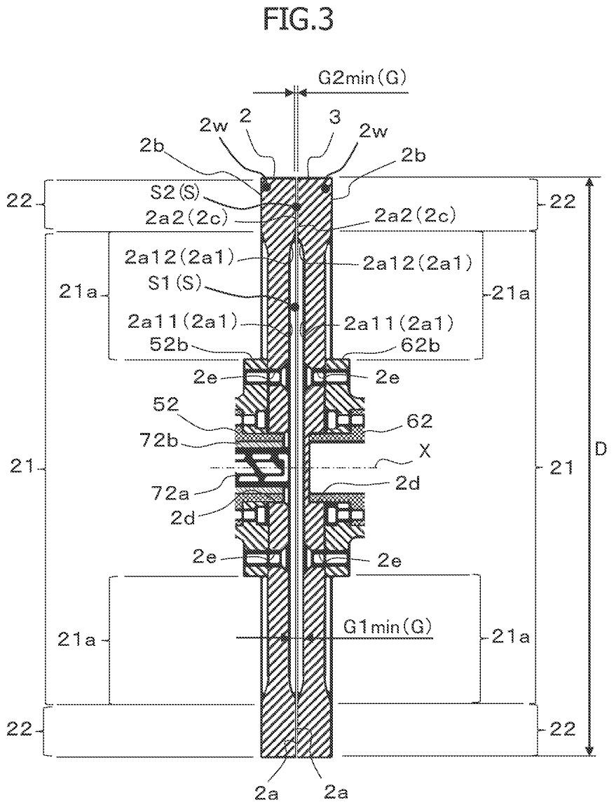

Embodiments of the present invention will hereinafter be described with reference to the drawings. FIG. 1 is an overall view for describing an internal structure and an entire structure of a main part of a disk type pulverizer 100 according to one embodiment of the present invention, FIG. 2 is a right side view of the disk type pulverizer, and FIG. 3 is an enlarged cross-sectional view of a main part of the disk type pulverizer 100. In FIG. 1, an upper half is a cross-sectional view and a lower half is a front view. In the cross-sectional view of the upper half in FIG. 1, the hatching that indicates the cross-section as illustrated in FIG. 3 is omitted to clarify the drawing. The disk type pulverizer 100 is also a disk type pulverizer used in a pulverizing method according to the present invention.

The disk type pulverizer 100 is an ultrahigh-speed rotation disk type pulverizer that performs dry fine pulverizing of the raw material particle, which is the pulverizing object, between disks (2, 3) that rotate at ultrahigh speed.

### [Overall Structure of Disk Type Pulverizer]

As illustrated in FIG. 1 and FIG. 2, in this embodiment, the disk type pulverizer 100 includes a base 1, a pair of disks 2 and 3, a casing 4, a first driving unit 5, a second driving unit 6, and a supply part 7.

The base 1 supports most of the components including the pair of disks 2 and 3 and the casing 4, and includes a top plate 1a with a rectangular shape in a top view and leg parts 1b provided at four corners of the top plate 1a.

The pair of disks 2 and 3 face each other with a space G therebetween and are rotated and driven in directions opposite to each other. The shape of one disk 2 and the shape of the other disk 3 are the same except whether or not a fitting hole 2d penetrates, which is discussed below, and the components of the disks 2 and 3 are described using the same reference signs. A space region S is provided between a counter surface 2a of one disk 2 of the pair of disks 2 and 3 that faces the other disk 3, and the counter surface 2a of the other disk 3 that faces the one disk 2. A disk rear surface 2b of each disk 2 on the opposite side of the counter surface 2a faces an inner wall surface of the casing 4 with a space therebetween.

In a case where the pair of disks 2 and 3 need to be distinguished, one disk 2 of the pair of disks 2 and 3 is hereinafter referred to as a first disk 2 and the other disk 3 of the pair of disks 2 and 3 is hereinafter referred to as a second disk 3. In FIG. 1, the first disk 2 is disposed on the left side and the second disk 3 is disposed on the right side. Note that the space region S between the pair of disks 2 and 3 and the shape of each of the disks 2 and 3 will be discussed below in detail.

The casing 4 is to form an accommodation chamber for accommodating the pair of disks 2 and 3. On a left side wall of the casing 4, a hole through which one end part of a first driving shaft 52, which is described below, of the first driving unit 5 is inserted is opened. On a right side wall of the casing 4, a hole through which one end part of a second driving shaft 62, which is described below, of the second driving unit 6 is inserted is opened. The casing 4 has an upper-lower half divided structure including an upper casing 41 and a lower casing 42, for example. The upper casing 41 is attached to the lower casing 42 so as to be able to open and close an opening at an upper part of the lower casing 42. In other words, the casing 4 is configured so that an upper part thereof can be released at the maintenance or disk change.

The casing 4 is attached to a center of the top plate 1a of the base 1 in a longitudinal direction and in a width direction, for example. A lower part of the lower casing 42 is open, and a hole is opened at a part of the top plate 1a that corresponds to the opening at the lower part of the lower casing 42. Additionally, at a position on a lower surface of the top plate 1a that corresponds to the lower casing 42, a discharge duct 43 through which the raw material particles after pulverizing are discharged is attached. The discharge duct 43 is formed to be narrowed downward and has a tip end part provided with a discharge flange part 43a having a discharge port.

Although not illustrated, suitable classifying means may be provided in a discharge path on a downstream side of the discharge flange part 43a of the discharge duct 43. The classifying means and the discharge path may be configured so that the particles over the target particle diameter are resupplied to a pulverizing part 2c (second region S2) through a first region S1 of the space region S between the pair of disks 2 and 3. That is to say, the disk type pulverizer 100 may be configured to be able to perform so-called closed-circuit pulverizing, that is, supply the particles over the target particle diameter into the pulverizing part 2c again and repeat the pulverizing. By performing the closed-circuit pulverizing, the disk type pulverizer 100 can perform the continuous pulverizing process into the smaller particle diameter than a so-called one-pass process of making the particles pass the pulverizing part 2c (second region S2) only once.

The first driving unit 5 is to rotate and drive the first disk 2, and includes a first electric motor 51 and the first driving shaft 52. The first driving unit 5, for example, rotates and drives the first disk 2 counterclockwise in a plan view that is viewed toward the counter surface 2a of the first disk 2.

The first electric motor 51 is a driving source for the rotation of the first disk 2, and is disposed below the top plate 1a. Specifically, in a left part below the top plate 1a, a first support plate 53 is provided. The first electric motor 51 is attached to the top plate 1a through the first support plate 53 so that a first motor shaft part 51a of the first electric motor 51 extends in a direction parallel to an upper surface of the top plate 1a. To the first motor shaft part 51a, a first motor side pulley 51b is attached.

The first driving shaft 52 is fastened to the disk rear surface 2b of the first disk 2. The first driving shaft 52 is supported above the upper surface of the top plate 1a in a manner of being rotatable around a rotation center line that coincides with a disk rotation center line X of the pair of disks 2 and 3. Specifically, in a left part of the upper surface of the top plate 1a, a first driving shaft support unit 54 with a first bearing group 54a including a pair of bearings is provided. The first driving shaft 52 is supported rotatably through the first bearing group 54a. The first driving shaft 52 includes one end part to be fitted to the fitting hole 2d, which is described below, formed in the first disk 2 and the other end part to which a first driving shaft side pulley 52a is attached. On the one end part side of the first driving shaft 52, a first flange part 52b for fastening with the first disk 2 is fixed. The one end part of the first driving shaft 52 protrudes from a flange surface of the first flange part 52b toward the second disk 3 side. A first driving belt 55 is wound across the first driving shaft side pulley 52a of the first driving shaft 52 and the first motor side pulley 51b. The rotation driving power from the first electric motor 51 is transmitted to the first disk 2 through the first driving belt 55 and the first driving shaft 52. The first driving shaft 52 is formed in a substantially hollow cylindrical shape. Inside the first driving shaft 52, an auger screw 72a and a supply tube 72b, which are described below, of the supply part 7 are inserted. Note that, in this embodiment, the first driving shaft 52 is fastened to the first disk 2, specifically a central disk part 21 of the first disk 2 through the first flange part 52b and the first driving shaft 52 corresponds to “disk rotation shaft” of the first disk 2 in the present invention.

The second driving unit 6 is to rotate and drive the second disk 3, and includes a second electric motor 61 and the second driving shaft 62. The second driving unit 6, for example, rotates and drives the second disk 3 counterclockwise in a plan view that is viewed toward the counter surface 2a of the second disk 3. Therefore, the first disk 2 and the second disk 3 rotate in the directions opposite to each other.

The second electric motor 61 is a driving source for the rotation of the second disk 3, and is disposed below the top plate 1a. Specifically, in a right region below the top plate 1a, a second support plate 63 is disposed. The second electric motor 61 is attached to the second support plate 63 so that a second motor shaft part 61a of the second electric motor 61 extends in the direction parallel to the upper surface of the top plate 1a. To the second motor shaft part 61a, a second motor side pulley 61b is attached.

The second driving shaft 62 is fastened to the disk rear surface 2b of the second disk 3. The second driving shaft 53 is supported above the upper surface of the top plate 1a in a manner of being rotatable around the rotation center line that coincides with the disk rotation center line X of the pair of disks 2 and 3. Specifically, in a right part of the upper surface of the top plate 1a, a second driving shaft support unit 64 with a second bearing group 64a including a pair of bearings is provided. The second driving shaft 62 is supported rotatably through the second bearing group 64a. The second driving shaft 62 includes one end part to be fitted to the fitting hole 2d, which is described below, formed in the second disk 3 and the other end part to which a second driving shaft side pulley 62a is attached. On the one end part side of the second driving shaft 62, a second flange part 62b for fastening with the second disk 3 is fixed. The one end part of the second driving shaft 62 protrudes from a flange surface of the second flange part 62b toward the first disk 2 side. A second driving belt 65 is wound across the second driving shaft side pulley 62a and the second motor side pulley 61b. The rotation driving power from the second electric motor 61 is transmitted to the second disk 3 through the second driving belt 65 and the second driving shaft 62. Note that, in this embodiment, the second driving shaft 62 is fastened to the second disk 3, specifically the central disk part 21 of the second disk 3 through the second flange part 62b and the second driving shaft 62 corresponds to “disk rotation shaft” of the second disk 3 in the present invention.

In this embodiment, the second driving unit 6 is configured to be able to move in the longitudinal direction of the top plate 1a along a pair of slide rails 1c and 1c extending along the longitudinal direction and provided at the upper surface of the top plate 1a. Specifically, a plurality of sliders 66 slidable along the slide rails 1c are attached to a bottom surface of the second driving shaft support unit 64 of the second driving unit 6. Then, between the pair of slide rails 1c and 1c at the top plate 1a, an opening part that is opened largely in a rectangular shape is formed. The second support plate 63 of the second driving unit 6 is fixed to a bottom surface of the second driving shaft support unit 64 through the opening part. At the base 1, a pair of fixing tools 1d (see FIG. 2) that fixes the second driving unit 6 to the top plate 1a so as to prevent the second driving unit 6 from moving along the pair of slide rails 1c and 1c is provided. In a normal operation, the movement of the second driving unit 6 is prevented by the pair of fixing tools 1d and at the maintenance or the like, the fixing by the pair of fixing tools 1d is released and the movement of the second driving unit 6 is allowed. Thus, the space G between the pair of disks 2 and 3 can be changed at, for example, the maintenance, disk change, or adjustment of the space G between the pair of disks 2 and 3 (adjustment of narrow gap). In addition, the first driving unit 5 and the second driving unit 6 can be operated individually and are configured to be able to perform a rotation performance test for each disk independently, which is described below.

In this embodiment, the driving units 5 and 6 are configured to be able to rotate and drive the corresponding disks 2 and 3 at a speed in the range where the relative speed at the outermost periphery between the pair of disks 2 and 3 is 340 to 440 m/s. Specifically, in the driving units 5 and 6, each bearing of the first bearing group 54a and the second bearing group 64a may be the existing bearing that satisfies the aforementioned relative speed and resists a predetermined rotation speed (for example, about 13000 rpm when the disk has a disk diameter D of 335 mm). Additionally, the first electric motor 51 and the second electric motor 61 may be the existing motor that has an output of the predetermined rotation speed (for example, 13000 rpm). Although not illustrated, each of the driving units 5 and 6 may include a cooling jacket to cool the first bearing group 54a and the second bearing group 64a. In addition, the high-speed rotation of the disks 2 and 3 causes the raw material particles to collide with the casing 4 at high speed and as a result, the temperature of the casing 4 itself can increase. Therefore, cooling means for cooling the casing 4 may be provided to the casing 4 as necessary depending on the kind of the raw material particles corresponding to the pulverizing object.

The supply part 7 supplies the pulverizing object to the first region S1 on the side of the disk rotation shaft (first driving shaft 52, second driving shaft 62) in the space region S between the counter surface 2a of the first disk 2 and the counter surface 2a of the second disk 3.

The supply part 7 includes, for example, a supply driving source 71, a feeding mechanism part 72, and a replenishment part 73.

The supply driving source 71 includes a supply electric motor 71a including an electric motor, and a motor support unit 71b that supports the supply electric motor 71a. To a motor shaft part 71al of the supply electric motor 71a, one end part of the auger screw 72a, which is described below, of the feeding mechanism part 72 is connected. The motor support unit 71b is fixed on the upper surface of the top plate 1a in the rear of the first driving unit 5 and supports the supply electric motor 71a.

The feeding mechanism part 72 includes the auger screw 72a with a screw blade, and the supply tube 72b with a cylindrical shape. The auger screw 72a is inserted into the supply tube 72b. The supply tube 72b is mostly inserted into a hollow part of the first driving shaft 52 of the first driving unit 5. One end part of the supply tube 72b reaches the one end part of the first driving shaft 52. The other end part of the supply tube 72b protrudes outward (to the left) from the other end part of the first driving shaft 52, and is connected to an end surface of the supply driving source 71. The auger screw 72a is configured to rotate in the supply tube 72b once the supply electric motor 71a is driven.

The replenishment part 73 is a so-called hopper that replenishes the supply tube 72b with the raw material particles. The replenishment part 73 is formed in a substantially tubular shape for storing the raw material particles, and is attached above the other end part of the supply tube 72b. The internal space of the replenishment part 73 communicates with the space inside the supply tube 72b at a lower end of the replenishment part 73.

In the supply part 7, once the auger screw 72a is rotated and driven by the supply driving source 71, the raw material particles filling the replenishment part 73 are sent into the space between the auger screw 72a and the supply tube 72b and transferred to the disk rear surface 2b of the first disk 2, and then, supplied to the space region S between the pair of disks 2 and 3. Although not limited in particular, air for air transportation is supplied to the supply tube 72b. In addition, the supply part 7 is configured to be able to adjust the feed quantity (g/min) of the raw material particles by changing the number of rotations of the supply electric motor 71a, for example.

### [Fundamental Structure of Disk]

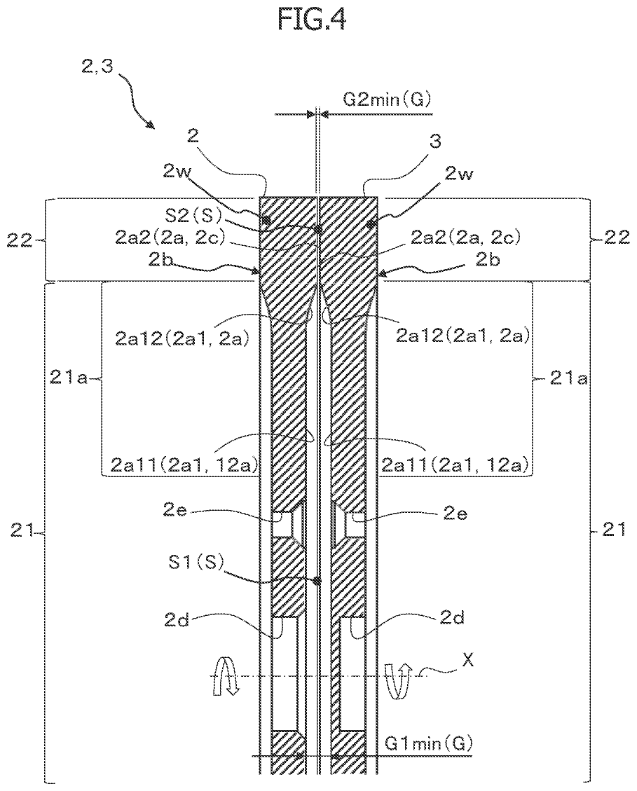

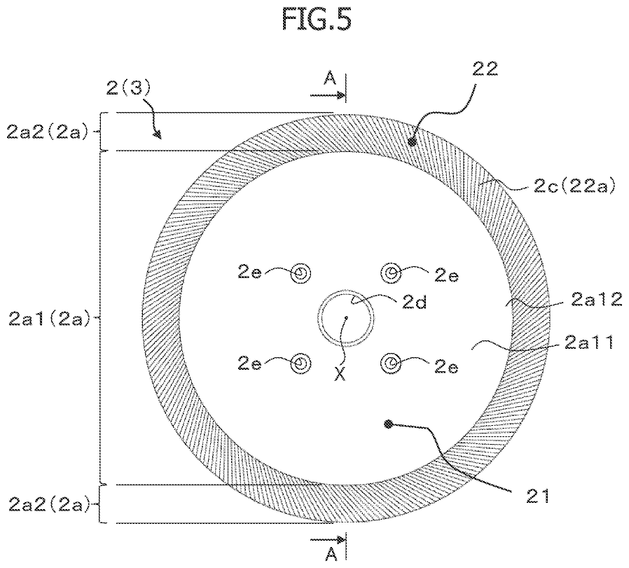

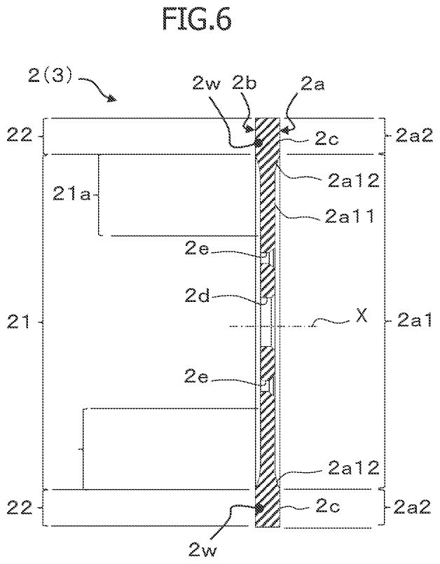

Next, a fundamental structure of the space region S between the pair of disks 2 and 3, the shape of each of the disks 2 and 3, and the like is mainly described with reference to FIG. 3 to FIG. 6. FIG. 4 is a conceptual view for describing the space G between the pair of disks 2 and 3. FIG. 5 is a front view of the disk 2 in which the disk 2 is viewed toward the counter surface 2a. FIG. 6 is a cross-sectional view taken along line A-A in FIG. 5.

As illustrated in FIG. 3 to FIG. 6, the disks 2 and 3 are formed in an approximately disk-like shape. In the disk type pulverizer 100, a minimum space G1min in the first region S1 on the side of the disk rotation shaft (that is, first driving shaft 52 and second driving shaft 62) in the space region S is set to be wider than a minimum space G2min in the second region S2 outside the first region S1 of the space region S. That is to say, the minimum space G2min in the second region S2 is set to be narrower than the minimum space G1min in the first region S1. In a part of the counter surface 2a of each of the disks 2 and 3 that corresponds to the second region S2 (annular part 2a2 to be described below), the pulverizing part 2c for pulverizing the pulverizing object is formed.

Each of the pair of disks 2 and 3 includes the central disk part 21 on the first region S1 side and a pulverizing disk part 22 on the second region S2 side. That is to say, each of the disks 2 and 3 of the disk type pulverizer 100 has the fundamental structure in which the pulverizing disk part 22 protrudes in a disk thickness direction relative to the central disk part 21 in the counter surface 2a. In other words, each of the disks 2 and 3 has the fundamental structure in which the central disk part 21 is depressed in the disk thickness direction relative to the pulverizing disk part 22 in the counter surface 2a.

In the disk type pulverizer 100 with the aforementioned fundamental structure, the pulverizing disk part 22 protrudes toward (gets close to) the counter surface 2a of the second disk 3 relative to the central disk part 21 in the counter surface 2a of the first disk 2 and similarly, the pulverizing disk part 22 protrudes toward (gets close to) the counter surface 2a of the first disk 2 relative to the central disk part 21 in the counter surface 2a of the second disk 3. The counter surface 2a of each of the disks 2 and 3 is sectioned into an inner side part 2al and the annular part 2a2. The inner side part 2al is a part corresponding to the first region S1 (central disk part 21). The annular part 2a2 is a part corresponding to the second region S2 (pulverizing disk part 22) (that is, this part corresponds to the outside of the inner side part 2a1).

The narrowest space (narrow gap) in the space region S is formed between the annular part 2a2 of the counter surface 2a of the first disk 2 and the annular part 2a2 of the counter surface 2a of the second disk 3, and is the minimum space G2min in the second region S2 of the space region S. That is to say, the pulverizing disk part 22 is a part that forms the narrow gap, and has a shape protruding in the disk thickness direction relative to the central disk part 21.

In this embodiment, the minimum space G2min in the second region S2 (that is, narrow gap) is set to a predetermined value in the range of 0.50 to 3.00 mm. The annular part 2a2 of the counter surface 2a of the pulverizing disk part 22 has a flat surface orthogonal to the disk rotation center line X, and a uniform narrow gap is provided in the second region S2. The narrow gap is defined by the closest portion between the annular part 2a2 of the counter surface 2a of the first disk 2 and the annular part 2a2 of the counter surface 2a of the second disk 3.

The central disk part 21 is depressed in the disk thickness direction relative to the pulverizing disk part 22 in the counter surface 2a as described above. As a result, the first region S1 corresponding to the central disk part 21 is provided as a region with a wide space. In the space region S, the space G largely changes at a border part between the pulverizing disk part 22 and the central disk part 21. Thus, by the provision of the first region S1 with the space widened to the inside in the radial direction of the second region S2 forming the narrow gap, the raw material particles can be sufficiently received in the first region S1 from the supply part 7. In a state where the pair of disks 2 and 3 are rotated and driven, the raw material particles received in the first region S1 are made into primary particles with the smaller particle size than the raw material particles in the first region S1. The raw material particles made into the primary particles are supplied to the second region S2 by centrifugal force or the like and pulverized in the second region S2. That is to say, the first region S1 formed by the central disk part 21 makes the raw material particles into the primary particles, and the primary particles are supplied to the second region S2. Therefore, generally, the conventional disk type pulverizer has a shape that the center of the counter surface is depressed. Note that the first region S1 can be expressed as a supply zone that functions as a region of supplying the raw material particles made into the primary particles to the second region S2, and the second region S2 can be expressed as a pulverizing zone that functions as a region of pulverizing the raw material particles made into the primary particles.

In this embodiment, the inner side part 2a1, which is a part of the counter surface 2a that corresponds to the central disk part 21, is formed to be depressed in a truncated conical shape. That is to say, the inner side part 2al includes a flat bottom surface part 2a11 orthogonal to the disk rotation center line X, and a connection surface part 2a12 connecting between an outer edge of the bottom surface part 2a11 and an inner edge of the annular part 2a2, which is a part of the counter surface 2a that corresponds to the pulverizing disk part 22. The connection surface part 2a12 is inclined in a direction away from the disk rear surface 2b as getting outward in the radial direction.

In this embodiment, the minimum space G1min in the first region S1 is set to 8 mm. Note that the minimum space G1min is not limited to this example and may be set preferably 4 mm or more and 15 mm or less, and more preferably 5 mm or more and 10 mm or less. Some of the conventional disk type pulverizers do not include the region corresponding to the first region S1 (supply zone). In such pulverizers, it is difficult to supply the raw material particles in the state of the primary particles to the second region S2 (pulverizing zone) with the narrow gap and thus, these pulverizers are not used for the fine pulverizing and are used for grinding or beating of fibers such as pulp or the like.

In this embodiment, the pulverizing part 2c includes a plurality of grooves 22a (in FIG. 5, 240 grooves) extending from the inner edge side of the annular part 2a2 of the counter surface 2a of each of the disks 2 and 3 to the outer edge side and disposed apart from each other in a disk circumferential direction. Each groove 22a is formed as a V-shaped groove (see the partially enlarged view in FIG. 1) without particular limitations. For example, the depth from the counter surface 2a of the V-shaped groove to the groove bottom is about 0.5 mm and the angle of the V shape is about 90°. The pulverizing disk part 22 pulverizes the raw material particles by having the grooves 22a in the annular part 2a2 of the counter surface 2a. The grooves 22a are not illustrated in FIG. 3, FIG. 4, and FIG. 6.

In this embodiment, the plurality of grooves 22a extend in a direction intersecting with a tangential line of the circumference (specifically, inner edge or outer edge of annular part 2a2) of each of the disks 2 and 3. Although not particularly limited, in FIG. 5, the grooves 22a linearly extend such that it is inclined with an angle (inclination angle) of 45° from the tangential line. The grooves 22a are inclined to be apart toward a tip end in the rotating direction as going from the inner edge side to the outer edge side of the annular part 2a2 in the drawing and are inclined in the rotating direction with respect to the disk radial direction. By the inclination of the grooves 22a in this manner, the staying time (passing time) of the raw material particles in the second region S2 (pulverizing zone) can be effectively increased.

Each of the disks 2 and 3 is formed of, for example, a suitable metal material such as carbon steel or stainless steel. Each of the disks 2 and 3 is formed by, for example, a cutting process or the like of a disk-shaped material made of the metal material. Additionally, in this embodiment, a substantially homogeneous (substantially uniform) material (that is, material with constant density) in the radial direction and the thickness direction is employed as the metal material of each of the disks 2 and 3.

The pulverizing part 2c (in other words, second region S2 or pulverizing zone) is provided in the entire annular part 2a2 in the range of ⅙ to ⅚ of the disk diameter D in the counter surface 2a. The pulverizing part 2c is provided in the annular part 2a2 of the counter surface 2a in the range of preferably ⅙ to ½ of the disk diameter D and more preferably ⅙ to ⅓ of the disk diameter D. When the range of the pulverizing part 2c in the entire counter surface 2a is more than ⅚ of the disk diameter, the first region S1 (supply zone) enough to make the raw material particles into the primary particles may not be secured and the raw material particles may be co-rotated with the disks 2 and 3 after the raw material particles enter the second region S2 (pulverizing zone) and before the raw material particles reach the outermost periphery where the speed is the highest. Accordingly, the range of the pulverizing part 2c in the entire counter surface 2a is preferably ⅚ or less of the disk diameter.

The disk diameter D is set to a predetermined diameter in the range of preferably 150 mm to 1500 mm, and more preferably 150 to 500 mm or 250 to 600 mm. The disk peripheral speed increases as the disks 2 and 3 are enlarged. However, the enlargement of the disks 2 and 3 results in the increase in weight of the disks; accordingly, the motive power of the motor and the load on the bearing need to be considered.

In each of the disks 2 and 3, the maximum disk thickness is the thickness of the pulverizing disk part 22 and is set to be ⅕ or less of the disk diameter D. The maximum disk thickness is set to be ⅛ or less of the disk diameter D and more preferably 1/10 or less of the disk diameter D. The disks 2 and 3 being thick is advantageous in deformation. However, the thicker disks are heavier and apply more burden on the bearing; thus, the increase in the disk thickness is not preferable for the high-speed rotation.

In this embodiment, in each of the disks 2 and 3, the disk diameter D is about 335 mm and the maximum disk thickness is about 20 mm, and the width on one side in the disk radial direction of the pulverizing disk part 22 where the pulverizing part 2c is formed is about 30 mm. Therefore, the pulverizing part 2c is provided to the annular part 2a2 of the counter surface 2a by 60/335 of the disk diameter D, that is, in the range of ⅙ to ⅓ of the disk diameter D in the counter surface 2a. The maximum disk thickness is set to be 20/335 or less (about 0.060, that is, 1/10 or less) of the disk diameter D.

At the center of the disk rear surface 2b of each of the disks 2 and 3, the fitting hole 2d to be fitted to the one end part of the corresponding driving shaft (52, 62) is formed. Here, the fitting hole 2d of the first disk 2 penetrates the first disk 2 for the raw material supply, and the fitting hole 2d of the second disk 3 does not penetrate and is formed until just before the counter surface 2a. In the periphery of the fitting hole 2d of each of the disks 2 and 3, a bolt hole 2e for fastening with the flange part (52b, 62b) around the corresponding driving shaft (52, 62) is formed. In the bolt hole 2e, spot facing processing is performed from the counter surface 2a side. End parts of the auger screw 72a and the supply tube 72b of the supply part 7 reach the vicinity of the opening on the counter surface 2a side in the fitting hole 2d of the first disk 2, and through this opening, the raw material particles are supplied to the first region S1 (supply zone).

The disk type pulverizer 100 with the structure described above has the aforementioned fundamental structure.

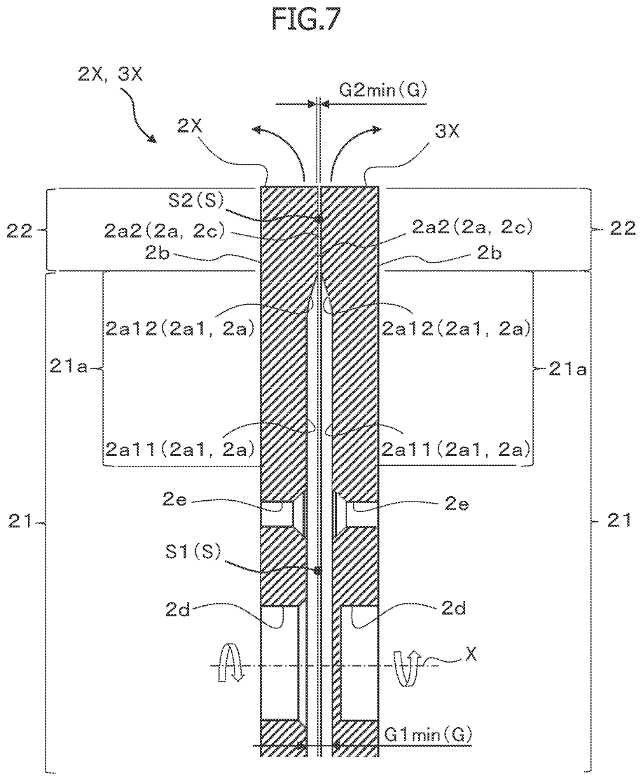

As a result of earnest examinations by the inventor of this application, the followings are discovered: (1) according to the aforementioned fundamental structure, the bending moment that warps the pulverizing disk part 22 in a direction away from the counterpart disk (2 or 3) (that is, warping toward the disk rear surface 2b) due to the centrifugal force acting on the pulverizing part 2c at the rotation and driving of the disks 2 and 3 acts on each disk, specifically, due to the centrifugal force, the rotation moment occurs in the pulverizing disk part 22 and this rotation moment acts on the pulverizing disk part 22 as the bending moment; (2) in particular, at the rotation and driving at higher speed than before as described in the present embodiment, the disks 2 and 3 may be deformed at the border part between the central disk part 21 and the pulverizing disk part 22 by the bending moment and the narrow gap between the pair of disks 2 and 3 may not be kept; and (3) in this case, the pulverizing disk part 22 can be deformed to be warped toward the disk rear surface 2b (see FIG. 7 described below); thus, the stable rotation becomes difficult and vibration and the like occur, and accordingly, it becomes difficult to rotate and drive the pair of disks 2 and 3 at the higher speed than before with the pair of disks 2 and 3 kept close to each other.

### [Warpage of Disk]

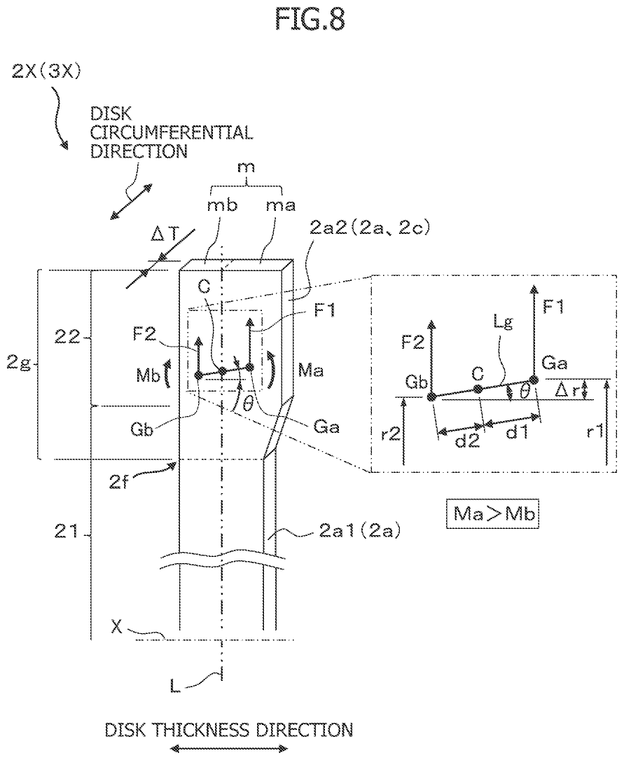

Using a pair of comparative disks 2X and 3X according to a comparative example to be compared with the pair of disks 2 and 3 in this embodiment as one example, the warpage that may occur due to the fundamental structure is described with reference to FIG. 7 and FIG. 8. FIG. 7 is a conceptual view for describing the warpage of the pair of comparative disks 2X and 3X according to the comparative example. FIG. 8 is a conceptual view for describing the rotation moment in the pair of comparative disks 2X and 3X. The comparative disks 2X and 3X have the same shape and size as the corresponding disks 2 and 3 except the part of the disks 2 and 3 in this embodiment that corresponds to a balance weight part 2w to be described below (in other words, except that the part of the disk rear surface 2b that corresponds to the central disk part 21 is not depressed and is flat). The same components as those of the disks 2 and 3 are denoted with the same reference signs and the description of such components is omitted.

As illustrated in FIG. 7, the comparative disks 2X and 3X have the fundamental structure similarly to the pair of disks 2 and 3. That is to say, in each of the comparative disks 2X and 3X, the pulverizing disk part 22 protrudes in the disk thickness direction relative to the central disk part 21 in the counter surface 2a and the central disk part 21 is depressed in the disk thickness direction relative to the pulverizing disk part 22 in the counter surface 2a. Since the central disk part 21 and the pulverizing disk part 22 are ring-shaped disks using the disk rotation center line X as a center, the center of gravity of the central disk part 21 and the center of gravity of the pulverizing disk part 22 exist on the disk rotation center line X. However, as the metal material forming the comparative disks 2X and 3X, the same material as that of the disks 2 and 3, that is, the material that is substantially homogeneous (substantially uniform) in the radial direction and the thickness direction is employed. Therefore, in the case where each of the comparative disks 2X and 3X is sectioned into the central disk part 21 and the pulverizing disk part 22, the center of gravity of the pulverizing disk part 22 is deviated by a predetermined deviation quantity to the counter surface 2a side in the disk thickness direction relative to the center of gravity of the central disk part 21. Here, similarly to the disks 2 and 3, to the disk rear surface 2b of the central disk part 21 of each of the comparative disks 2X and 3X, the corresponding flange part (first flange part 52b, second flange part 62b) is firmly fastened; therefore, a part of the central disk part 21 that is on the inside in the radial direction relative to the flange part (52b, 62b) is a rigid body as if that part were unified with the flange part (52b, 62b). Therefore, regarding the deviation of the center of gravity of the central disk part 21 relative to the pulverizing disk part 22, at least the annular part 21a on the outside in the radial direction relative to the part of the central disk part 21 to which the flange part (52b, 62b) is fastened may be considered.

Due to the deviation of the center of gravity, the bending moment to make the pulverizing disk part 22 warp toward the disk rear surface 2b may act on each of the comparative disks 2X and 3X. In the case where the comparative disks 2X and 3X are rotated and driven at the higher speed than before, when the relative speed of the outermost periphery is over the range of 280 to 300 m/s in particular, the stress of the bending moment that acts on each of the comparative disks 2X and 3X may concentrate on the border part between the central disk part 21 and the pulverizing disk part 22. As a result, each of the comparative disks 2X and 3X (pulverizing disk part 22) may deform so as to warp toward the disk rear surface 2b. In this case, the space G on the outer peripheral side of the pulverizing disk part 22 may be enlarged and the space G may be narrowed in the end part of the pulverizing disk part 22 on the disk rotation center line X side (inner edge part of annular part 2a2).

With reference to FIG. 8, the cause of the warpage occurrence in each of the comparative disks 2X and 3X with the fundamental structure is examined more specifically. In this examination, the following geometric and dynamic virtual definitions are made regarding each of the comparative disks 2X and 3X as illustrated in FIG. 8. The following definitions also apply to the disks 2 and 3 according to this embodiment.

As illustrated in FIG. 8, first, a line that passes the center, in the disk thickness direction, of a thinnest part 2f of an outer peripheral part of the central disk part 21 and that is orthogonal to the disk rotation center line X is defined as a reference line L. Each of virtual segments obtained by dividing a ring-shaped part 2g on the outside in the radial direction relative to the thinnest part 2f of each of the comparative disks 2X and 3X in the disk circumferential direction in units of a predetermined length ΔT is defined as a virtual segment piece m. Each of the virtual segment pieces m is sectioned into a first piece ma on the counter surface 2a side and a second piece mb on the opposite side (on the disk rear surface 2b side) of the counter surface 2a by the reference line L. Additionally, a virtual rotation moment of the first piece ma around an intersection C between a line Lg connecting a center of gravity Ga of the first piece ma and a center of gravity Gb of the second piece mb, and the reference line L is defined as a first moment Ma, and a virtual rotation moment of the second piece mb around the intersection C is defined as a second moment Mb. Note that in FIG. 8, only one (one sheet of) virtual segment piece m is illustrated for simplifying the drawing and the fitting hole 2d is not illustrated.

Specifically, the thinnest part 2f is the thinnest part in the range on the outside relative to ½ of the disk radius of the comparative disks 2X and 3X and on the inside relative to a central side end part in the radial direction of the pulverizing disk part 22. That is to say, the position of the thinnest part 2f in the radial direction based on the disk rotation center line X exists in the range on the outside relative to ½ of the disk radius of the comparative disks 2X and 3X and on the inside relative to the central side end part in the radial direction of the pulverizing disk part 22. As illustrated in FIG. 8, however, in a case where the position of the thinnest part in the radial direction cannot be specified in the above range (in other words, a part with the same thickness exists), the thinnest part 2f corresponds to the part existing on the outermost peripheral side in the radial direction.

The first moment Ma and the second moment Mb are rotation moments that occur due to the centrifugal force (Fa, Fb) at the disk rotation driving. The first moment Ma and the second moment Mb are defined based on the following expressions (1) to (5):

$$Ma = ( F 1 \times cos θ ) \times d 1 \qquad Expression ( 1 )$$

$$Mb = ( F 2 \times cos θ ) \times d 2 \qquad Expression ( 2 )$$

$$F 1 = m 1 \times r 1 \times {ω}^{2} \qquad Expression ( 3 )$$

$$F 2 = m 2 \times {r}^{2} \times {ω}^{2} \qquad Expression ( 4 )$$

$$r 1 = r 2 + Δ r \qquad Expression ( 5 )$$

F1 and F2 represent the centrifugal force that acts on the center of gravity Ga and Gb at the disk rotation and driving, θ represents the inclination angle of the line Lg connecting the center of gravity Ga and the center of gravity Gb relative to the disk rotation center line X (that is, the angle between the line Lg and the disk rotation center line X), d1 represents the distance between the center of gravity Ga and the intersection C, and d2 represents the distance between the center of gravity Gb and the intersection C. Additionally, m1 represents the weight of the first piece ma, m2 represents the weight of the second piece mb, r1 represents the position of the center of gravity Ga in the radial direction from the disk rotation center line X, r2 represents the position of the center of gravity Gb in the radial direction from the disk rotation center line X, ω represents the angular speed of the rotation of the disks 2 and 3, and Ar represents the differential value between r1 and r2.

With the use of each parameter defined as above, the warpage that may occur in each of the comparative disks 2X and 3X with the fundamental structure is described. As illustrated in FIG. 8, the first moment Ma is the counterclockwise rotation moment using the intersection (in other words, fulcrum) C as the center and the second moment Mb is the clockwise rotation moment using the intersection C as the center in each of the comparative disks 2X and 3X. In each of the comparative disks 2X and 3X, the distance d1 is larger than the distance d2 (d1>d2) and the weight m1 is larger than the weight m2 (m1>m2); thus, the value of the first moment Ma is larger than the value of the second moment Mb (Ma>Mb). Therefore, as the value of the first moment Ma becomes larger than the value of the second moment Mb, the bending moment for warping the pulverizing disk part 22 toward the disk rear surface 2b increases. Thus, it is necessary to set the differential value ΔM between the value of the first moment Ma and the value of the second moment Mb to be low in order to suppress the warpage. Note that, for example, in the case of employing a plurality of materials with different specific gravities as the disk material, for example forming the pulverizing part 2c in the pulverizing disk part 22 with another material with high hardness, the center of gravity Ga and the center of gravity Gb are calculated considering the difference in specific gravity.

### [Characteristic Structure of Disk]

In consideration of the above, each of the disks 2 and 3 in this embodiment has the following characteristic structure in order to prevent or suppress the warpage of the disks 2 and 3.

The pulverizing disk part 22 in each of the disks 2 and 3 includes the balance weight part 2w in the part on the opposite side of the counter surface 2a of itself.

In this embodiment, the balance weight part 2w is formed so as to protrude in the disk thickness direction relative to the part of the disk rear surface 2b of itself that corresponds to the first region S1.

Methods for balancing the weight by forming the protruding balance weight part 2w include: (1) cutting a part of the disk rear surface 2b that corresponds to the central disk part 21 so that a part of the disk rear surface 2b that corresponds to the central disk part 21 is depressed into a shape symmetric to the inner side part 2al of the counter surface 2a; and (2) attaching another member to a part of the disk rear surface 2b that corresponds to the pulverizing disk part 22. From the viewpoints of strength and durability, it is preferable to form the protruding balance weight part 2w by cutting rather than attaching another member.

In this embodiment, the disks 2 and 3 have the external shape that the parts of the pulverizing disk parts 22 on both sides in the disk thickness direction protrude symmetrically. Note that the pulverizing disk parts 22 of the disks 2 and 3 may not be formed to have the completely symmetric shape. In this case, in each of the disks 2 and 3, a ratio R (see Expression (6) below) of the differential value ΔM between the value of the first moment Ma and the value of the second moment Mb to the value of the second moment Mb may be set to be a predetermined ratio (%) or less. Since the grooves 22a as the pulverizing parts 2c are formed on the counter surface 2a side of the pulverizing disk part 22, setting the ratio R (in other words, proportion) in the predetermined range requires, strictly speaking, the consideration of the shape of the pulverizing parts 2c and the like.

$$R = ( M a - Mb ) / Mb = Δ M / Mb \qquad Expression ( 6 )$$

When the first moment Ma is smaller than the second moment Mb (Ma<Mb), the bending moment may act in a direction of narrowing the minimum space G2min in the second region S2 that forms the narrow gap, which is not preferable. Therefore, the disks 2 and 3 are formed so that the first moment Ma will not become smaller than the second moment Mb considering the fabrication tolerance.

In this embodiment, the value of the first moment Ma coincides with the value of the second moment Mb (Ma=Mb) and the center of gravity of the pulverizing disk part 22 coincides with the center of gravity of the annular part 21a of the central disk part 21. That is to say, the differential value ΔM (=Ma−Mb) is zero and the ratio R (=ΔM/Mb) is zero. Note that the embodiment is not limited to this example, and the value of the first moment Ma does not need to coincide with the value of the second moment Mb and the ratio R may be set to the predetermined ratio (%) or less. In this case, the center of gravity of the pulverizing disk part 22 may be deviated in the disk thickness direction relative to the center of gravity of the annular part 21a of the central disk part 21 in the range according to the allowable ratio R.

Specifically, by cutting a metal disk with a diameter of 355 mm and a thickness of 20 mm, the pulverizing part 2c and the depressed inner side part 2al are formed on one surface (counter surface 2a) of the metal disk, and the width of the pulverizing disk part 22 in the radial direction is set to 30 mm on one side. Additionally, the same cutting process as that for the inner side part 2al of the counter surface 2a is also performed on the part of the disk rear surface 2b that corresponds to the central disk part 21. For example, a part of the counter surface 2a that corresponds to the central disk part 21 and a part of the disk rear surface 2b that corresponds to the central disk part 21 are cut at a depth of 4 mm. Finally, a part of the disk rear surface 2b that corresponds to the pulverizing disk part 22 is cut to be flat by the same cutting quantity as the cutting quantity (cutting volume) for forming the pulverizing part 2c. Thus, the value of the first moment Ma coincides with the value of the second moment Mb and a center of gravity C2 of the pulverizing disk part 22 coincides with a center of gravity C1 of the annular part 21a of the central disk part 21. As described above, in the case where the value of the first moment Ma does not coincide with the value of the second moment Mb, the ratio R is set to be 15% or less, preferably 10% or less, more preferably 5% or less, and desirably 3% or less.

In the pair of disks 2 and 3 with the aforementioned structure (hereinafter referred to as disk A1 as appropriate), the following has been confirmed by the performance tests below: by making the center of gravity of the pulverizing disk part 22 coincide with the center of gravity of the annular part 21a of the central disk part 21 and making the value of the first moment Ma coincide with the value of the second moment Mb, the deformation due to the bending moment at the high-speed rotation is suppressed or prevented effectively and the ultrahigh-speed rotation with the relative speed over 340 m/s is possible and thus, such disks 2 and 3 are suitable for the fine pulverizing.

### [Performance Test]

Next, regarding the disk type pulverizer 100 according to this embodiment, description is made of the result of the rotation performance test for confirming that the disk A1 is capable of high-speed rotation and the result of the pulverizing performance test for confirming that the disk A1 is capable of fine-pulverizing the raw material particles.

An operator conducted the rotation performance test and the pulverizing performance test using the disk A1 in accordance with the following procedure.

### [Rotation Performance Test]

(1) Each of the disks 2 and 3 of the disk A1 is rotated and driven independently in the range of 500 to 13000 rpm with the space G between the disks 2 and 3 sufficiently widened compared to that in the normal operation, and the absence of the abnormal vibration or abnormal noise is confirmed.

(2) If there is no problem about the abnormal vibration or abnormal noise, the rotation of each of the disks 2 and 3 is stopped. Then, the second driving unit 6 (movable side unit) is slid in a direction toward the first driving unit 5 (fixed side unit) along the pair of slide rails 1c and 1c, and by using a thickness gauge, the space G (the minimum space G2min in the second region S2) is set. Here, it is confirmed that the minimum space G2min at four points, upper, lower, left, and right points, is constant with respect to the disks 2 and 3.

(3) If there is no problem about the minimum space G2min, the pair of disks 2 and 3 are rotated in the directions opposite to each other in the order of the number of rotations of 500 rpm, 1000 rpm, 3000 rpm, 5000 rpm, 7000 rpm, 8000 rpm, 9000 rpm, 10000 rpm, 11000 rpm, 12000 rpm, and 13000 rpm, and the absence of the abnormal vibration or abnormal noise of the disks is confirmed.

Regarding the disk A1, it has been confirmed that neither vibration nor abnormal noise occurred when the minimum space G2min was 1.00 mm and the number of rotations of the disks 2 and 3 was in the range of 500 to 13000 rpm. Subsequently, it has been confirmed that neither vibration nor abnormal noise occurred when the minimum space G2min was 0.50 mm and the number of rotations of the disks 2 and 3 was in the range of 500 to 13000 rpm.

### [Pulverizing Performance Test]

In the pulverizing performance test, the particle diameter after the aforementioned one-pass process was checked and after another supply, the pulverizing performance evaluation was conducted.

If the pulverizing process by the closed circuit pulverizing was performed in the pulverizer including the classifying means to perform the pulverizing performance test, the coarse powder is subjected to re-processing; therefore, fine pulverizing proceeds apparently and it becomes difficult to grasp the essential potential of the pulverizing part 2c. Therefore, in the pulverizing performance test about the disk A1, the particle diameter after the one-pass process was checked in order to evaluate the pulverizing performance purely. After that, the particles after the one-pass process were resupplied and the change in the particle diameter distribution was checked; thus, the pulverizing performance evaluation was conducted.

After the absence of the problem in the rotation performance test was confirmed, the pulverizing performance test was conducted with the raw material particles supplied. Specifically, the pulverizing performance test was conducted for each of the three cases in which the minimum space G2min in the disk A1 was 3.00 mm, 1.00 mm, and 0.50 mm. In each test, under the condition where the number of rotations was 10000 rpm (relative speed of 350 m/s), the pulverizing performance test in the one-pass process was performed with the use of the test particles (calcium carbonate) with a d50 (median diameter) of 350 μm before the pulverizing and with the feed quantity set to 15 g/min.

As a result of the pulverizing performance test, in the case where the minimum space G2min was 3.00 mm, the d50 after the pulverizing was 9.6 μm, the ratio of the particles with a particle diameter of 1 μm or less was 2.91 wt %, and the ratio of the particles with a particle diameter of 100 μm or more was 32.3 wt %. In the case where the minimum space G2min was 1.00 mm, the d50 after the pulverizing was 5.7 μm, the ratio of the particles with a particle diameter of 1 μm or less was 3.34 wt %, and the ratio of the particles with a particle diameter of 100 μm or more was 24.7 wt %. In the case where the minimum space G2min was 0.50 mm, the d50 after the pulverizing was 5.3 μm, the ratio of the particles with a particle diameter of 1 μm or less was 3.62 wt %, and the ratio of the particles with a particle diameter of 100 μm or more was 25.1 wt %. Because of the one-pass process, the coarse powder of 100 μm or more is included in any case; however, regarding d50, the sufficient pulverizing performance is achieved in any case. It has been confirmed that the pulverizing performance is achieved particularly when the minimum space G2min is 0.5 mm to 1.0 mm. Furthermore, as a result of resupplying the one-pass process pulverizing object obtained under the condition where the minimum space G2min was 1.00 mm, the d50 after the pulverizing was 3.6 μm, the ratio of the particles with a particle diameter of 1 μm or less was 3.50 wt %, and the ratio of the particles with a particle diameter of 100 μm or more was 0.0 wt %. The excessive increase of the fine powder was not observed after the two processes and the fine powder of 100 μm or more disappeared, and it has been confirmed that the fine-pulverizer with the excellent performance was obtained.

### Comparative Example

Next described are the results of the pulverizing performance test and the rotation performance test and the ratio R of the difference ΔM to the second moment Mb about the pair of comparative disks 2X and 3X. As the pair of comparative disks 2X and 3X, a comparative disk illustrated in FIG. 7 and FIG. 8 (hereinafter referred to as comparative disk X1 as appropriate) and a comparative disk X2 that is not illustrated are given in the description. The comparative disk X2 has the same shape and size as the comparative disk X1 except that the inner side part 2al in the counter surface 2a is not depressed and is formed flatly so as to continue to the annular part 2a2.

In the comparative disk X1, the reference line Lg and the center of the pulverizing disk part 22 in the disk thickness direction are deviated by 2.00 mm in the disk thickness direction. In other words, the center of gravity of the pulverizing disk part 22 is deviated by 2.00 in the disk thickness direction relative to the center of gravity of the annular part 21a of the central disk part 21. The weight m1 of the first piece ma is larger than the weight m2 of the second piece mb. Regarding the comparative disk X1, the ratio R (=ΔM/Mb) calculated based on Expressions (1) to (6) was 97.5%.

As a result of performing the rotation performance test on the comparative disk X1 similarly to the disk A1, vibration occurred due to the deformation of the disk when the number of rotations was 8000 rpm (relative speed 280 m/s).

The comparative disk X2 was subjected to the pulverizing performance test under the condition in which the minimum space G2min was 1.00 mm and the number of rotations was 5000 rpm (relative speed 175 m/s). In this case, there was no problem in the rotation of the disk itself; however, it was difficult to supply the raw material particles to the first region S1 in the counter surface 2a and the raw material particles stayed in the supply tube 72b of the supply part 7. Therefore, the pulverizing performance test was conducted with the feed quantity reduced. In this case, the pulverized particles had a d50 of 290 μm.

Next, the pulverizing method using the disk type pulverizer 100 according to this embodiment is described. This pulverizing method is a method of pulverizing the raw material particles as the pulverizing object using the disk type pulverizer 100. This pulverizing method includes sectioning each of the pair of disks 2 and 3 into the central disk part 21 on the first region S1 side and the pulverizing disk part 22 on the second region S2 side, and providing the balance weight part 2w in a part of the pulverizing disk part 22 on the side opposite to the counter surface 2a.

In the disk type pulverizer 100 and the pulverizing method using the same in this embodiment, the pulverizing disk part 22 includes the balance weight part 2w in the part of the pulverizing disk part 22 on the side opposite to the counter surface 2a of itself in the structure on the premise of the fundamental structure. That is to say, the balance weight part 2w is provided to the part of the pulverizing disk part 22 on the opposite side of the pulverizing part 2c that causes the bending moment to warp the pulverizing disk part 22 toward the disk rear surface 2b. Therefore, the balance weight part 2w can cause the bending moment in the direction of canceling the bending moment in each of the disks 2 and 3 to act on the pulverizing disk part 22. As a result, by providing the balance weight part 2w as appropriate in accordance with the pulverizing part 2c, the narrow gap (minimum space G2min) between the pair of disks 2 and 3 can be kept and the pair of disks 2 and 3 can be rotated and driven at the higher speed than before with the pair of disks 2 and 3 kept close to each other.

In this manner, the disk type pulverizer 100 including the pair of disks 2 and 3 that face each other closely and can rotate at higher speed than before, and the pulverizing method using this disk type pulverizer 100 can be provided.

Note that the value of the first moment Ma coincides with the value of the second moment Mb in the disk A1 according to this embodiment; however, the embodiment is not limited to this example and the values of both moments may not be the same. The ratio R may be set to the predetermined ratio (%) or less and the center of gravity of the pulverizing disk part 22 may be deviated in the disk thickness direction relative to the center of gravity of the annular part 21a of the central disk part 21 in the range according to the allowable ratio R. The following has been confirmed by the performance tests below: by setting the ratio R within the predetermined range, the deformation due to the bending moment at the high-speed rotation is suppressed or prevented effectively and the ultrahigh-speed rotation with the relative speed over 340 m/s is possible and thus, such disks are suitable for the fine pulverizing.

Specifically, by changing the cutting depth of the part of the disk rear surface 2b that corresponds to the central disk part 21 (supply zone) on the basis of the disk A1, disks A2 to A5 corresponding to Examples with the ratio R (=ΔM/Mb) changed were manufactured (see Table 1). In the disks A1 to A5, the ratio R is adjusted to be a predetermined value in the range of 3.00% to 15.00%, preferably 0.00% to 10.00%, more preferably 0.00% to 5.00%, and still more preferably 0.00% to 3.00%.

TABLE 1

| | Disk A1 | Disk A2 | Disk A3 | Disk A4 | Disk A5 |
|---|---|---|---|---|---|
| Ratio R (%) | 0.00 | 3.00 | 5.00 | 10.00 | 15.00 |

In the rotation performance test about the disks A2 to A5, it has been confirmed that the vibration or abnormal noise was absent when the minimum space G2min was 1.00 mm and 0.50 mm and the number of rotations was in the range of 500 to 13000 rpm. The pulverizing performance test about the disks A2 to A5 was conducted about the case in which the minimum space G2min was 1.00 mm. In this pulverizing test, the pulverizing performance test in the one-pass process was performed under the condition where the number of rotations was 10000 rpm (relative speed 350 m/s) using the test particles (calcium carbonate) with a d50 (median diameter) before the pulverizing of 350 μm with the feed quantity set to 15 g/min. The results of this pulverizing performance test are shown in Table 2 below. Subsequently, similarly, the one-pass pulverizing processing object was resupplied and the pulverizing performance test was conducted. The results are shown in Table 3 below. Thus, it has been confirmed that the disk type pulverizer 100 has the excellent performance as the fine pulverizer in any case of the disks A2 to A5.

TABLE 2

| One-pass process | Disk A2 | Disk A3 | Disk A4 | Disk A5 |
|---|---|---|---|---|
| d50 (μm) | 5.9 | 5.7 | 5.6 | 6.2 |
| 1 μm or less wt % | 3.21 | 3.25 | 3.15 | 3.05 |
| 100 μm or less wt % | 24.3 | 24.2 | 25.1 | 30.2 |

TABLE 3

| Resupply process | | | | |
|---|---|---|---|---|
| (Two processes) | Disk A2 | Disk A3 | Disk A4 | Disk A5 |
| d50 (μm) | 3.7 | 3.7 | 3.8 | 4.2 |
| 1 μm or less wt % | 3.58 | 3.56 | 3.57 | 3.41 |
| 100 μm or less wt % | 0.00 | 0.00 | 0.00 | 0.00 |

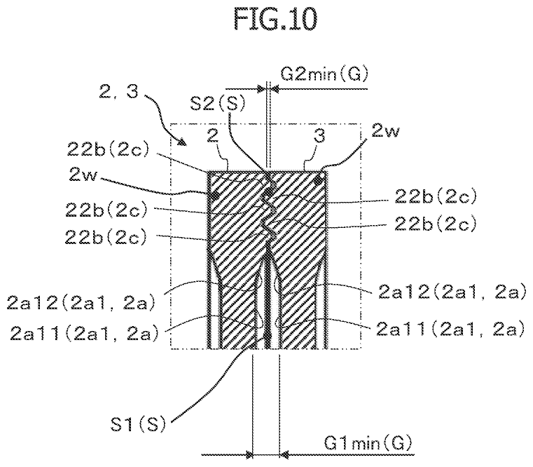

Note that in this embodiment, the pulverizing part 2c of the first disk 2 and the pulverizing part 2c of the second disk 3 are apart from each other without overlapping with each other in the disk thickness direction; however, the arrangement is not limited to this example. As illustrated in FIG. 10, the pulverizing part 2c of the first disk 2 and the pulverizing part 2c of the second disk 3 may be a lap type with a concavoconvex shape so that these pulverizing parts overlap with each other. In this case, the pulverizing part 2c includes a plurality of projections 22b formed extending in the disk circumferential direction at positions at intervals in the disk radial direction, and between the two projections 22b adjacent to each other in the radial direction in the first disk 2, the projection 22b of the second disk 3 enter. Thus, the residence time (passing time) of the raw material particles in the second region S2 (pulverizing zone) can be effectively increased.

Moreover, the specific gravity of the balance weight part 2w may be set higher than the specific gravity of the part of the pulverizing disk part 22 on the counter surface 2a side. In this case, the balance weight part 2w may be flat and continue to the part of the disk rear surface 2b that corresponds to the pulverizing part 2c without protruding in the disk thickness direction relative to the part of the disk rear surface 2b that corresponds to the first region S1.

While the preferred embodiments of the present invention have been described as above, the present invention is not limited to the embodiments and the modifications descried above, and various modifications and changes are possible on the basis of the technical concept of the present invention.

### REFERENCE SIGNS LIST

2, 3 a pair of disks
2 one disk
2a counter surface
2a2 annular part (part of counter surface that corresponds to second region)
2b disk rear surface
2c pulverizing part
2w balance weight part
2f thinnest part
2g ring-shaped part
21 central disk part
22 pulverizing disk part
22a groove
3 the other disk
100 disk type pulverizer
C intersection
D disk diameter
G space
Ga center of gravity of first piece
Gb center of gravity of second piece
G1min minimum space in first region
G2min minimum space in second region
L reference line
Lg line connecting center of gravity of first piece and center of gravity of second piece
m virtual segment piece
ma first piece
mb second piece
m1 weight of first piece
m2 weight of second piece
Ma first moment
Mb second moment
S space region
S1 first region
S2 second region
X disk rotation center line

1. A disk type pulverizer comprising:
a pair of disks that face each other with a space therebetween and are rotated and driven in directions opposite to each other; and
a supply part that supplies a pulverizing object to a first region on a disk rotation shaft side in a space region between a counter surface of one disk of the pair of disks with respect to the other disk and a counter surface of the other disk with respect to the one disk, wherein
a minimum space in the first region of the space region is set to be wider than a minimum space in a second region outside the first region of the space region, and a pulverizing part for pulverizing the pulverizing object is formed in a part of the counter surface that corresponds to the second region,
each of the pair of disks includes a central disk part on a side of the first region and a pulverizing disk part on a side of the second region, and
the pulverizing disk part includes a balance weight part in a part on a side opposite to the counter surface; and
in a case where a line passing a center, in a disk thickness direction, of a thinnest part of an outer peripheral part of the central disk part and being orthogonal to a disk rotation center line is a reference line, each of a plurality of virtual segment pieces obtained by dividing a ring-shaped part on an outside in a radial direction relative to the thinnest part of the disk in units of a predetermined length in a disk circumferential direction is sectioned into a first piece on the side of the counter surface and a second piece on the side opposite to the counter surface by the reference line, and a virtual rotation moment about the first piece using, as a center, an intersection between the reference line and a line connecting a center of gravity of the first piece and a center of gravity of the second piece is a first moment and a virtual rotation moment about the second piece using the intersection as a center is a second moment, a ratio of a differential value between a value of the first moment and a value of the second moment to the value of the second moment is set to be 15% or less.

2. The disk type pulverizer according to claim 1, wherein the balance weight part is formed to protrude in a disk thickness direction relative to a part of a disk rear surface, which is a surface on the side opposite to the counter surface, that corresponds to the first region.

3. The disk type pulverizer according to claim 1, wherein a specific gravity of the balance weight part is set to be higher than a specific gravity of a part of the pulverizing disk part on a side of the counter surface.

4. The disk type pulverizer according to claim 1, wherein the minimum space in the second region is set to be a predetermined value in a range of 0.50 to 3.00 mm.

5. (canceled)

6. The disk type pulverizer according to claim 1, wherein the ratio is set to be 10% or less.

7. The disk type pulverizer according to claim 1, wherein the ratio is set to be 5% or less.

8. The disk type pulverizer according to claim 1, wherein the value of the first moment coincides with the value of the second moment.

9. The disk type pulverizer according to claim 1, wherein the pair of disks are configured to be able to rotate at a speed in a range where a relative speed of an outermost periphery is 340 to 440 m/s.

10. The disk type pulverizer according to claim 1, wherein each of the pair of disks has a maximum disk thickness of ⅕ or less of a diameter of the disk.

11. The disk type pulverizer according to claim 10, wherein the maximum disk thickness is 1/10 or less of the diameter of the disk.

12. The disk type pulverizer according to claim 1, wherein the pulverizing part includes a plurality of grooves extending from an inner edge side to an outer edge side of the part of the counter surface that corresponds to the second region and being apart from each other in the disk circumferential direction.

13. The disk type pulverizer according to claim 12, wherein the plurality of grooves extend in a direction of intersecting with a tangential line of a circumference of each disk.

14. The disk type pulverizer according to claim 1, wherein the pulverizing part of the one disk and the pulverizing part of the other disk are a lap type formed in a concavoconvex shape so that these pulverizing parts overlap with each other.

15. A pulverizing method for pulverizing a pulverizing object using a disk type pulverizer including a pair of disks that face each other with a space therebetween and are rotated and driven in directions opposite to each other, and a supply part that supplies the pulverizing object to a first region on a disk rotation shaft side in a space region between a counter surface of one disk of the pair of disks with respect to the other disk and a counter surface of the other disk with respect to the one disk, wherein a minimum space in the first region of the space region is set to be wider than a minimum space in a second region outside the first region of the space region, and a pulverizing part for pulverizing the pulverizing object is formed in a part of the counter surface that corresponds to the second region, the pulverizing method comprising:
sectioning each of the pair of disks into a central disk part on a side of the first region and a pulverizing disk part on a side of the second region; and
providing a balance weight part in a part of the pulverizing disk part on a side opposite to the counter surface, wherein in the disk type pulverizer, in a case where a line passing a center, in a disk thickness direction, of a thinnest part of an outer peripheral part of the central disk part and being orthogonal to a disk rotation center line is a reference line, each of a plurality of virtual segment pieces obtained by dividing a ring-shaped part on an outside in a radial direction relative to the thinnest part of the disk in units of a predetermined length in a disk circumferential direction is sectioned into a first piece on the side of the counter surface and a second piece on the side opposite to the counter surface by the reference line, and a virtual rotation moment about the first piece using, as a center, an intersection between the reference line and a line connecting a center of gravity of the first piece and a center of gravity of the second piece is a first moment and a virtual rotation moment about the second piece using the intersection as a center is a second moment, a ratio of a differential value between a value of the first moment and a value of the second moment to the value of the second moment is set to be 15% or less.
